(19) United States
(12) Patent Application Publication
(10) Pub. No.: US 2026/0041092 A1
(43) Pub. Date: Feb. 12, 2026

(54) Composition Protecting Wood Against Marine Woodborers

(71) Applicant: I-Tech AB, Mölndal (SE)

(72) Inventors: Anders Larsson, Täby (SE); Pia Larsson Brelid, Göteborg (SE); Dan Isaksson, Mölndal (SE); Markus Hoffmann, Sant Cugat (ES)

(73) Assignee: I-Tech AB, Mölndal (SE)

(21) Appl. No.: 19/107,289

(22) PCT Filed: Aug. 31, 2023
(86) PCT No.: PCT/EP2023/073866

§ 371 Date: Feb. 27, 2025

(30) Foreign Application Priority Data
Sep. 1, 2022 (EP) 22193512.5

(51) Int. Cl. A01N 43/50; A01N 25/02; A01P 9/00; C09D 5/16

(52) U.S. Cl. CPC A01N 43/50; A01N 25/02; A01P 9/00; C09D 5/1625

(57) ABSTRACT

The present embodiments relate to a method for reducing or preventing attacks from marine woodborers on wood in marine environment by impregnating the wood with a composition comprising medetomidine, or an enantiomer, salt or base thereof.

### TECHNICAL FIELD

The present embodiments generally relate to a method for impregnating wood with a composition with the aim to prevent or at least reduce attacks from woodborer on the wood in marine environment.

### BACKGROUND

Wood in marine environment is attacked by various woodborers including, but not limited to, shipworms and gribbles. The woodborers make their way through the wood and create tunnels in the wood. Attacks by woodborers can often only be seen as small holes on the surface while on the inside the larvae create larger and larger burrowing as they grow. The larvae line the inside with a calcareous material. A fully grown shipworm can be up to 60 cm long and 1 cm in diameter. These attacks by woodborers compromise the structural integrity of the wood and constructions made from it. After an attack it might be only a matter of months before the wood is completely destroyed and needs to be replaced.

In the eighteenth-century, copper sheathing was used on wooden ships as a method to prevent damage by marine woodborers. Furthermore, it was also discovered that chemicals, such as creosote, or compositions, such as chromated copper arsenate (CCA), could be used to impregnate and protect wood against woodborers. These well-established and generally effective preservatives for marine wood structures are now restricted or prohibited in many countries due to legislation (European Commission, 2003) triggered by concerns over effects of these treatments on non-target organisms.

WO 2013/131940 discloses a method for reducing or preventing the attack of marine woodborers on wood situated in a marine environment by impregnating the wood with a biocidal composition comprising tralopyril. However, tralopyril may be embryotoxic, have malformation potential in aquatic animals and may cause thyroid endocrine disruption (Ecotoxicology and Environmental Safety (2021) 223:112615).

WO 2013/141821 discloses a marine woodborer resistant composition comprising a set of base polymers intended for exposure to a liquid environment, in which marine woodborers are expected to exist, and a phthalocyanine compound.

JP 2018-080275 discloses an antifouling coating composition containing a polyether-modified silicone oil, an antifouling agent, and a film-forming resin.

EP 2432315 discloses preparation of small polymer microcapsules with an oil core and solid microspheres, comprising high amounts of biocide by internal phase separation from emulsion droplets with ethyl acetate as a solvent. The size of the microcapsules and microspheres is between 0.2-20 μm in diameter.

There is still a need for a treatment of wood structures that are exposed to marine environment for the purpose of preventing or at least reducing attacks made by marine woodborers.

### SUMMARY

It is a general objective to protect wood structures that are exposed to marine environment from attacks made by marine woodborers, such as shipworms and gribbles.

This and other objectives are met by embodiments as disclosed herein.

The present invention is defined in the independent claims. Further embodiments of the invention are defined in the dependent claims.

An aspect of the embodiments relates to a method for reducing or preventing attacks of marine woodborers on wood present in a marine environment. The method comprising impregnating at least a portion of the wood with a composition comprising medetomidine, or an enantiomer, salt or base thereof, in an amount of at least 0.05 wt % based on a total weight of the composition.

Another aspect of the embodiments relates to use of a composition comprising medetomidine, or an enantiomer, salt or base thereof, in an amount of at least 0.05 wt % based on a total weight of the composition for reducing or preventing attacks of marine woodborers on wood present in a marine environment.

The medetomidine composition of the present invention is capable protecting wood in marine environments, such as piles, piers, ship hulls and similar constructions, against attacks from woodborers, such as shipworms and gribbles. The medetomidine composition is further safe to handle by workers and environment from a health, safety and environment (HSE) perspective at the intended use. The medetomidine composition is additionally able to penetrate into the wood, thereby allowing a sufficient amount of medetomidine, or an enantiomer, salt or base thereof, to be absorbed by the wood to ensure a long-lasting protective effect.

### BRIEF DESCRIPTION OF THE DRAWINGS AND TABLES

The embodiments, together with further objects and advantages thereof, may best be understood by making reference to the following description taken together with the accompanying drawings and tables, in which:

FIG. 1 illustrate treated and non-treated wooden test pieces after one year of immersion. Top left is a non-treated reference wooden test piece. Remaining wooden test pieces had been treated with 0.8% ethanol solution made from a medetomidine concentrate (20%) in 1-methoxy-2-propanol as described in Example 1.

FIG. 2 illustrates wooden test pieces after 1 year of immersion. First column: chromated copper arsenate (CCA) treated reference wooden test pieces, second column: non-treated reference wooden test pieces, third column: solution A (0.1%) treated wooden test pieces, fourth column: solution B (0.5%) treated wooden test pieces, fifth column: solution C (1.0%) treated wooden test pieces. Solutions A, B and C were prepared by diluting a concentrate made up of 10 part of medetomidine, 9 parts acetic acid and 9 parts water as described in Example 1.

### DETAILED DESCRIPTION

The foregoing and other aspects of the embodiments will now be described in more detail with respect to the description and methodologies provided herein. It should be appreciated that the invention may be embodied in different forms and should not be construed as limited to the embodiments set forth herein. Rather, these embodiments are provided so that this disclosure will be thorough and complete, and will fully convey the scope of the invention to one of ordinary skill in the art.

The one of ordinary skill in the art will understand that terminology used in the description herein is for the purpose of describing particular embodiments only and is not intended to be limiting of the invention. Unless otherwise defined, all terms, including technical and scientific terms used in the description, have the same meaning as commonly understood by one of ordinary skill in the art to which this invention belongs.

As used in the description of the embodiments, the singular forms “a”, “an” and “the” are intended to include the plural forms as well, unless the context clearly indicates otherwise. Thus, such references may be replaced with a reference to “one or more”, e.g., one, of the relevant component or integer. As used herein, all references to “one or more” of a particular component or integer will be understood to refer to from one to a plurality, e.g., two, three or four, of such components or integers. It will be understood that references to “one or more” of a particular component or integer will include a particular reference to one such integer. Also, as used herein, “and/or” refers to and encompasses any and all possible combinations of one or more of the associated listed items. Furthermore, the term “about,” as used herein when referring to a measurable value, such as an amount of a compound, dose, time, temperature, and the like, refers to variations of 20%, 10%, 5%, 1%, 0.5%, or even 0.1% of the specified amount. When a range is employed, e.g., a range from x to y, it is meant that the measurable value is a range from about x to about y, or any range or value therein including x and y. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof.

All patents, patent applications and publications referred to herein are incorporated by reference in their entirety. In the event of conflicting terminology, the present specification is controlling.

“Wood” as used herein encompass all forms of wood including, but not limited to, solid wood, such as timber or lumber, for instance, in the form of logs, beams, planks, sheets and boards, wood composite materials, such as plywood, laminated lumber, or wood plastic composites, and all products made from wood and wood-composite materials. Illustrative, but non-limiting, examples of such wood products include ship hulls, harbor installations, drydocks, piers, sluice gates, locks, mooring masts, wooden poles, bridges, bulkheading and similar.

“Woodborer” as used herein refers to marine woodborers belonging to molluscs or crustaceans. The woodborer molluscs include bivalve molluscs of the family Pholadidae, also known as piddocks or angelwings, and bivalve molluscs of the family Teredinidae, also known as shipworms. The woodborer crustaceans are marine isopods from the family Limnoriidae, also referred to as gribble, woodlice from the family Armadillidiidae, also referred to as pill bugs or roly polies, and amphipods of the family Cheluridae. Particular common marine woodborers include Teredo navalis, commonly called the naval shipworm or turu, and Limnoria lignorum, commonly known as the gribble.

The present embodiments generally relate to a method for impregnating wood with a composition with the aim to prevent or at least reduce attacks from woodborer on wood in marine environment.

It has been found that attacks from marine woodborers on wood in a marine environment can be prevented, or least reduced, by impregnating the wood with a medetomidine composition prior to immersion of the wood in the marine environment.

An aspect of the embodiments therefore relates to a method for reducing or preventing attacks of marine woodborers on wood present in a marine environment. The method comprises impregnating at least a portion of the wood with a composition comprising medetomidine, or an enantiomer, salt or base thereof, in an amount of at least 0.05 weight percentage (wt %) based on a total weight of the composition.

Medetomidine, also referred to as (±)-4-[1-(2,3-dimethylphenyl)ethyl)-1H-imidazole, see formula I, is a highly selective α2-adrenoreceptor agonist. There are two tautomers of the imidazole group of medetomidine resulting in 4-[1-(2,3-dimethylphenyl)ethyl)-1H-imidazole as shown in formula I or its tautomer 5-[1-(2,3-dimethylphenyl)ethyl)-1H-imidazole.

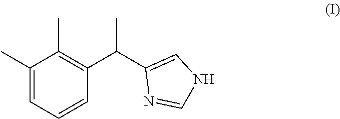

Medetomidine is a racemic mixture of the two optical enantiomers, the levo- and dextro-rotary optical isomers (Journal of pharmacology and experimental therapeutics (1991) 259:848-854; European Journal of Pharmacology (1991) 195:193-199) with generic names levomedetomidine and dexmedetomidine, respectively. Processes for the preparation of medetomidine and related intermediates is disclosed in, for instance, WO 2011/070069 and WO 2013/014428.

The terms medetomidine, dexmedetomidine, and levomedetomidine as used herein include salts, bases and solvates thereof unless specifically stated otherwise. Acceptable salts of medetomidine, dexmedetomidine, and levomedetomidine include acid addition salts and base addition salts. Such salts may be formed by conventional means, for example by reaction of a free acid or a free base form of medetomidine, dexmedetomidine, and levomedetomidine with one or more equivalents of an appropriate acid or base, optionally in a solvent, or in a medium, in which the salt is insoluble, followed by removal of the solvent, or the medium, using standard techniques, e.g., in vacuum or by freeze-drying. Salts may also be prepared by exchanging a counter-ion of medetomidine, dexmedetomidine, and levomedetomidine in the form of a salt with another counter-ion, for example using a suitable ion exchange resin. An illustrative, but non-limiting, example of a salt of medetomidine is medetomidine hydrochloride. For the avoidance of doubt, other acceptable derivatives of medetomidine, dexmedetomidine, and levomedetomidine are included within the scope of the invention, e.g., solvates, etc.

The enantiomers of medetomidine may be isolated and separated from each other by separation of racemic or other mixtures of the enantiomers using chiral resolution or chiral column chromatography known in the art. Alternatively, the desired enantiomer may be prepared by enantio-selective synthesis, also called chiral synthesis or asymmetric synthesis, which is defined as a chemical reaction, or reaction sequence, in which one or more new elements of chirality are formed in a substrate molecule and which produces the stereoisomeric products in unequal amounts.

The base form of medetomidine is distributed by the company I-Tech AB under the product name SELEKTOPE®.

As used herein, a “medetomidine composition” or “medetomidine solution” encompasses a composition or solution comprising medetomidine, or an enantiomer, salt or base thereof.

In the following, various aspects and embodiments of the present invention are described in further detail with reference to medetomidine. These aspects and embodiments also encompass an enantiomer of medetomidine, such as dexmedetomidine or levomedetomidine, a salt of medetomidine, a salt of dexmedomidine, or a salt of levomedetomidine, or a base of medetomidine, a base of dexmedomidine, or a base of levomedetomidine collectively denoted medetomidine, or an enantiomer, base or salt thereof herein. Thus, reference to medetomidine herein should be regarded as relating to medetomidine, a salt of medetomidine, a base of medetomidine, dexmedetomidine, a salt of dexmedetomidine, a base of dexmedetomidine, levomedetomidine, a salt of levomedetomidine, and/or a base of levomedetomidine unless indicated otherwise.

Use of a medetomidine composition, such as a medetomidine solution, in accordance with the embodiments can prevent, inhibit, discourage, or significantly delay the incursion, intrusion, or penetration of one or more types of marine woodborers, such as boring bivalve molluscs and crustations, therein for a period of at least 3 months, or even longer, such as several months, e.g., 6-9 months, or one or more years, e.g., 1-10 years, or 2-5 years. Materials, structures, or objects, collectively referred to as wood or wood products herein, which are impregnated using a medetomidine composition, such as a medetomidine solution, in accordance with the embodiments on and/or within surfaces that are exposed or exposable to a marine environment comprising marine woodborers or which are at risk of marine woodborer attacks can prevent, inhibit, discourage, or significantly delay marine woodborer incursion, intrusion, or penetration into such surfaces for corresponding time periods or the duration of a service or deployment life.

Accordingly, impregnating wood with a medetomidine composition, such as a medetomidine solution, in accordance with the embodiments will make the wooden material, structures, or objects made thereof marine woodborer attack-resistant.

In an embodiment, the composition comprises medetomidine, or the enantiomer, salt or base thereof, in an amount ranging from 0.05 wt % to 5 wt % based on the total weight of the composition. In a preferred embodiment, the composition comprises medetomidine, or the enantiomer, salt or base thereof, in an amount ranging from 0.1 wt % to 5 wt % based on the total weight of the composition, and preferably in an amount ranging from 0.1 wt % to 2.5 wt % based on the total weight of the composition. More preferably, the composition comprises medetomidine, or the enantiomer, salt or base thereof, in an amount ranging from 0.5 wt % to 2.5 wt % based on the total weight of the composition, preferably in an amount ranging from 0.5 wt % to 1.0 wt % based on the total weight of the composition.

In an embodiment, the composition is a solution comprising medetomidine, or the enantiomer, base or salt thereof. Hence, in such an embodiment, the medetomidine composition is a medetomidine solution comprising medetomidine, or the enantiomer, base or salt thereof, dissolved or dispersed in a solvent.

In an embodiment, the solvent is selected from the group consisting of water, a carboxylic acid, an alcohol and any combination thereof. Currently preferred carboxylic acids include methanoic acid (formic acid), ethanoic acid (acetic acid), propanoic acid (propionic acid) and butanoic acid (butyric acid), and more preferably ethanoic acid, i.e., acetic acid. Currently preferred alcohols include methanol, ethanol, propan-2-ol, butan-1-ol, ethane-1,2-diol, propane-1,2-diol, butane-1,2-diol, propane-1,3-diol, butane-1,3-diol, butane-1,4-diol, benzyl alcohol, and 1-methoxypropan-2-ol (propylene glycol methyl ether (PGME) or 1-methoxy-2-propanol).

In a particular embodiment, the solvent is selected from the group consisting of water, acetic acid, methanol, ethanol, butane-1,4-diol, benzyl alcohol, 1-methoxypropan-2-ol, or any combination thereof.

Solubility of medetomidine in water is dependent on pH and temperature with a higher solubility at low pH and higher temperatures and decreasing solubility with higher pH and lower temperatures.

In an embodiment, the solution is an acidic aqueous solution comprising medetomidine, or the enantiomer, salt or base thereof. The acidic aqueous solution then has an acidic pH, i.e., a pH below 7. In a preferred embodiment, the pH of the acidic aqueous solution is selected within an interval of from 4 to 6, and more preferably selected within an interval of from 4.5 to 5.5. A currently preferred pH of the acidic aqueous solution is within 4.6 to 5.4, within 4.7 to 5.3, within 4.8 to 5.2, or within 4.9 to 5.1, such as about 5.0.

It is preferred if the acidic aqueous solution used to impregnate the wood, or at least a portion thereof, has a pH of around 5 to be compatible with the wood. Large differences in pH between the wood and the acidic aqueous solution might trigger precipitation of medetomidine, or the enantiomer, salt or base thereof, in the acidic aqueous solution resulting in less penetration of medetomidine, or the enantiomer, salt or base thereof, into the wood during impregnation.

The acidic aqueous solution is preferably in the form of a mixture of at least one acid and water, in particular a mixture of at least carboxylic acid and water, such as a mixture of acetic acid and water.

For instance, concentrated acidic aqueous solutions can prepared by dissolving medetomidine (10 parts) in concentrated acetic acid (9 parts) and water (9 parts) at room temperature. The resulting concentrated acidic aqueous solution is then diluted to the appropriate use solution by addition of water.

In an embodiment, the method comprises dissolving medetomidine, or the enantiomer, salt or base thereof, in an acidic aqueous solvent to form a concentrated acidic aqueous solution having a first pH. In a particular embodiment, the concentrated acidic aqueous solution is a mixture of at least one acid, preferably at least one carboxylic acid, and more preferably acetic acid, and water. The method then comprises diluting the concentrated acidic aqueous solution with water to form the acidic solution having a second pH. The first pH is below the second pH and the second pH is below 7, preferably selected within an interval of from 4 to 6, and more preferably selected within an interval of from 4.5 to 5.5, such as about 5.0.

Medetomidine solutions are generally easier to prepare in organic solvents, such as alcohols, but with added drawbacks associated with such organic solvents, such as in terms of worker safety and flammability issues. Illustrative, but non-limiting, examples of suitable organic solvents are methanol, ethanol, butane-1,4-diol, benzyl alcohol, 1-methoxypropan-2-ol. For instance, a concentrate of medetomidine, or the enantiomer, salt or base thereof, in the organic solvent could first be produced. The concentrate can then be diluted with a suitable solvent, such as an organic solvent and/or water, for the impregnation

Impregnating the at least a portion of the wood comprises, in an embodiment, impregnating at least a portion of a wood product with the medetomidine composition, such as the medetomidine solution. The wood product is then a product made of wood or at least comprises wood and where the wood product or at least the wood part or parts of the wood product are intended to be at least partly immersed in a marine environment. In a particular embodiment, at least a portion of at least one wood surface of the wood product is impregnated with the medetomidine composition, such as the medetomidine solution.

As mentioned in the foregoing, the method comprises impregnating at least a portion of the wood with the medetomidine composition, such as the medetomidine solution. In an embodiment, only a portion of the wood is impregnated with the medetomidine composition, such as the medetomidine solution. For instance, merely a portion of the wood product may be exposed to the marine environment and can therefore be attacked by marine woodborers. Any remaining portion of the wood product could, for instance, be present outside of the water, i.e., not submersed in water during use. Alternatively, the remaining portion of the wood product could be protected by a surface coating, sheet or layer that prevents marine woodborers from reaching the underlying wood. In such embodiments, merely the portion of the wood that is exposed and vulnerable to attacks by marine woodborers is impregnated with the medetomidine composition, such as the medetomidine solution.

In another embodiment, the method comprises impregnating the wood with the medetomidine composition, such as the medetomidine solution. In this embodiment, the whole or at least substantially the whole wood product is impregnated with the medetomidine composition, such as the medetomidine solution. This then means that preferably all surfaces of the wood product are impregnated to protect them and the wood from attacks by marine woodborers once the wood produce is immersed in a marine environment.

The impregnation of at least a portion of the wood with the medetomidine composition, such as the medetomidine solution, can be performed according to various embodiment. In an embodiment, the at least a portion of the wood is impregnated with the medetomidine composition, such as the medetomidine solution, in a closed high-pressure system.

In this embodiment, the wood, or at least the portion thereof to be treated with the medetomidine composition, is exposed to a high pressure while being in contact with the medetomidine composition, such as the medetomidine solution. High pressure as used herein implies a pressure above ambient pressure, i.e., above 1 bar. In a particular embodiment, the wood is exposed to a pressure of at least 2 bar, such as at least 3 bar, at least 4 bar or at least 5 bar, or even higher, such as at least 6 bar, at least 7 bar, at least 8 bar, at least 9 bar or at least 10 bar, during the impregnation. It is also possible to use even higher pressures in this embodiment.

An example of a closed high-pressure system is the “full-cell process”, also called “Bethell process”, which is a method of impregnating wood with preservatives, devised in the 19^{th} century by the U.S. inventor John Bethell. It involves sealing the wood in a pressure chamber and applying a vacuum in order to remove air and moisture from the wood cells. The wood is then pressure-treated with preservatives to impregnate the full wood cell (that is, the cell wall as well as the lumen, or interior) with substances that impart, for instance resistance to decay, fire, insects, and woodboring marine animals. Such a Bethell process could be used to impregnate the at least a portion of the wood with the medetomidine composition, such as the medetomidine solution, according to the embodiments.

Another example of a closed high-pressure system is the co-called “Ruping process”, in which the wood is placed in an impregnation boiler under increased pressure followed by the introduction of the medetomidine composition, such as the medetomidine solution, and release of pressure.

In another embodiment, the at least a portion of the wood is impregnated with the medetomidine composition, such as the medetomidine solution, in a vacuum system. Hence, in this embodiment, the at least a portion of the wood is impregnated with the medetomidine composition, such as the medetomidine solution, solution under vacuum. Vacuum as used herein refers to a pressure below ambient pressure, such as equal to or below 500 mbar, equal to or below 100 mbar, equal to or below 10 mbar, equal to or below 1 mbar, or even lower.

In a further embodiment, the at least a portion of the wood is impregnated with the medetomidine composition, such as the medetomidine solution, while applying oscillating pressure or a sequence of vacuum cycles. In the former case, the wood could, during the impregnation, be exposed to alternating pressures, such a X1 bar, X2 bar, X1 bar, X2 bar, and so forth, wherein X1>X2 or X1<X2. For instance, one of X1 and X2 could be 1 bar, i.e., ambient pressure, whereas the other of X1 and X2 is then a pressure above ambient pressure. A similar approach could be applied in the case of a sequence of vacuum cycles by alternating between a reduction of pressure below ambient pressure, a pressure equal to or above ambient pressure, a reduction of pressure below ambient pressure, a pressure equal to or above ambient pressure, and so forth.

Further embodiments of impregnating the at least a portion of the wood is to dip or soak the at least a portion of the wood in the medetomidine composition, such as the medetomidine solution. Also other techniques for impregnating the at least a portion of the wood can be used such as by applying the medetomidine composition, such as the medetomidine solution, by painting the at least a portion of the wood with the medetomidine composition, such as the medetomidine solution, or by brush application.

### EXAMPLES

### Example 1—Impregnation Solutions

### Solvent-Based Impregnation Solution

Medetomidine (200 g, SELEKTOPE®, I-Tech AB) was dissolved in 1-methoxy-2-propanol to form 1 liter solution. The medetomidine solution was diluted with ethanol to a final concentration of 0.8% medetomidine by weight, which was used as impregnation solution.

### Water-Based Impregnation Solutions

Medetomidine is not very water soluble and to increase the solubility, acetic acid was used to protonate the imidazole ring in medetomidine.

0.1% Solution A 5 g of medetomidine (SELEKTOPE®, I-Tech AB), 4.5 g of acetic acid and 4.5 g of water were mixed in a 100 ml E-flask and was left with stirring. A clear solution was obtained after 60 min. The solution was diluted with water to a final weight of 5 kg.

### 0.5% Solution B

25 g of medetomidine (SELEKTOPE®, I-Tech AB), 22.5 g of acetic acid and 22.5 g of water were mixed in a 100 ml E-flask and was left with stirring. A clear solution was obtained after 60 min. The solution was diluted with water to a final weight of 5 kg.

### 1.0% Solution C

50 g of medetomidine (SELEKTOPE®, I-Tech AB), 45 g of acetic acid and 45 g of water were mixed in a 250 ml flask and was left with stirring. A clear solution was obtained after 30 min. The solution was diluted with water to a final weight of 5 kg.

### Example 2

Impregnation with Solvent-Based Solution

Wooden test pieces (EN 252, Pine, 25× 50× 150 mm) were prepared. The wooden pieces were full-cells impregnated with the 0.8% 1-methoxy-2-propanol/ethanol solution from Example 1 using an autoclave. After impregnation the wooden pieces were air dried for one week at room temperature (20-25° C.) in a fume hood.

Impregnation with Water-Based Solution

Pine sapwood (Pinus sylvestris L) wooden test pieces (22.4×48×163 mm) were prepared. Prior to impregnation, the tangential and radial surfaces of the wooden test pieces were planed. The wooden test pieces were then conditioned at 20° C. and 65% relative humidity (Rh). Ten wooden test pieces were used for moisture measurements. They were oven-dried for 18 h at 103° C., and the weight was recorded. The average moisture content prior to impregnation was 8.6%.

The wooden test pieces were packed together separated from each other, with a plastic grid. 20 pieces were placed in each of three plastic containers and were held in place by weights ensuring that the wooden test pieces were kept submerged during the whole impregnation process. One of three different medetomidine solutions (Solution A, Solution B and Solution C, all from Example 1) were added to each container. The containers were put in an autoclave. The impregnation procedure started with an initial step where the containers with the wooden test pieces were kept under vacuum for 30 min to remove air from the wood structures. This was followed by applying a pressure of 10 bar for 1 hour.

The wooden test pieces were weighed directly after impregnation to record the wet uptake (kg/m³), then left to air-dry for 12 hours before oven-drying for 18 hours at 103° C. The average wet uptake was above 700 kg/m³ for all of the impregnation solutions A, B and C.

TABLE 1
impregnation solution uptake

| Impregnation | Average impregnation | Weight percent gain after |
|---|---|---|
| solution | solution uptake [kg/m³] | drying |
| A | 758 | 1.73 |
| B | 717 | 2.17 |
| C | 740 | 4.86 |

### Example 3

### First Field Test

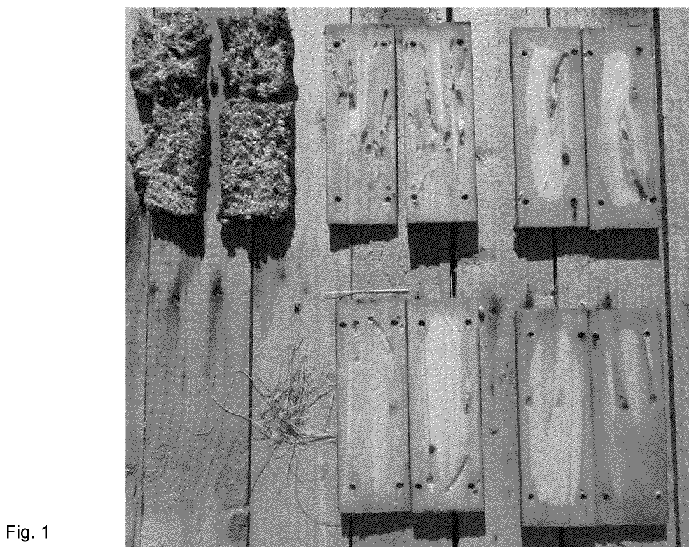

The wooden test pieces impregnated with the solvent-based solution were mounted on aluminum frames and submerged at Kristineberg Marine biological research station on the west coast of Sweden from 1^{st} of June 2020 until 28^{th} of May 2021. The non-treated references (FIG. 1, top left) were completely perforated by shipworms. The wooden test pieces treated with the 0.8% ethanol solution of medetomidine (Example 1) had only a few shipworms as shown in FIG. 1.

### Second Field Tests

The wooden test pieces impregnated with the various water-based solution (Example 1) were mounted on aluminum frames and submerged at Kristineberg Marine biological research station on the west coast of Sweden from 28^{th} of May 2021 until 9^{th} of June 2022.

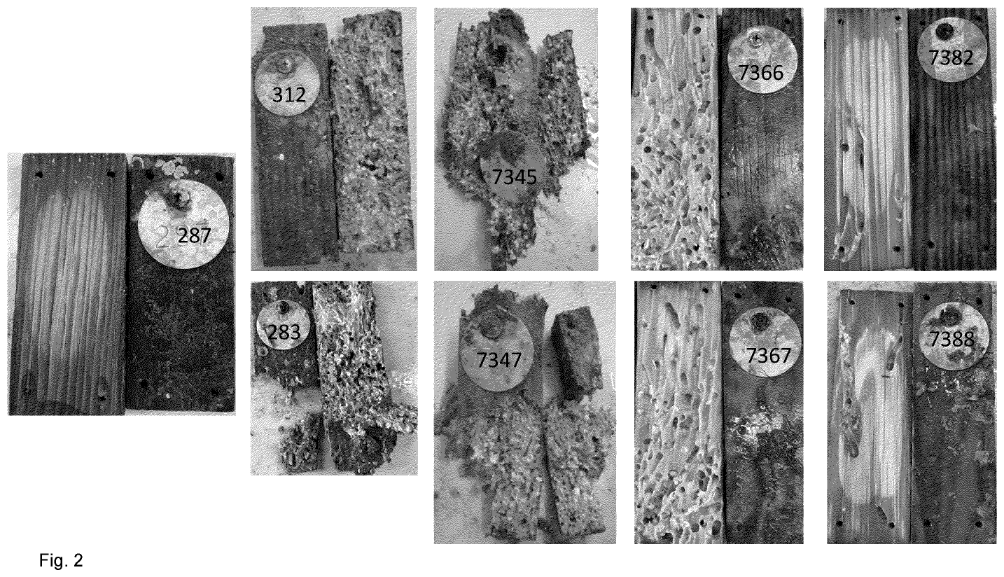

FIG. 2 and Table 2 show the results after 1 year of immersion of the wooden test pieces impregnated with water-based solutions of various medetomidine concentrations (0.1%, 0.5% and 1% prepared in Example 1) as well as treated and non-treated references.

TABLE 2
test results

| Name/ | | |
|---|---|---|
| Number | Description | Result in crosscut |
| Tr Ref 287 | CCA-Treated | Pristine, no shipworms inside |
| | reference | |
| Ref 312 | non-treated ref | Completely perforated |
| | | by shipworms |
| Ref 283 | non-treated ref | Completely perforated |
| | | by shipworms |
| 7345 | 0.1% treated | Completely perforated |
| | | by shipworms |
| 7347 | 0.1% treated | Completely perforated |
| | | by shipworms |
| 7366 | 0.5% treated | Fairly perforated by shipworms |
| 7367 | 0.5% treated | Fairly perforated by shipworms |
| 7382 | 1% treated | Only a few shipworms |
| 7388 | 1% treated | Only a few shipworms |

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method for reducing or preventing attacks of marine woodborers on wood present in a marine environment, the method comprising impregnating at least a portion of the wood with a composition comprising medetomidine, or an enantiomer, salt or base thereof, in an amount of at least 0.05 wt % based on a total weight of the composition.

2. The method as claimed in claim 1, wherein the composition comprises medetomidine, or the enantiomer, salt or base thereof, in an amount ranging from 0.05 wt % to 5 wt % based on the total weight of the composition.

3. The method as claimed in claim 2, wherein the composition comprises medetomidine, or the enantiomer, salt or base thereof, in an amount ranging from 0.1 wt % to 5 wt % based on the total weight of the composition, preferably in an amount ranging from 0.1 wt % to 2.5 wt % based on the total weight of the composition.

4. The method as claimed in claim 3, where the composition comprises medetomidine, or the enantiomer, salt or base thereof, in an amount ranging from 0.5 wt % to 2.5 wt % based on the total weight of the composition, preferably in an amount ranging from 0.5 wt % to 1.0 wt % based on the total weight of the composition.

5. The method as claimed in any one of claims 1 to 4, wherein the composition is a solution comprising medetomidine, or the enantiomer, salt or base thereof.

6. The method as claimed in claim 5, wherein the solution comprises a solvent selected from the group consisting of water, a carboxylic acid, an alcohol, and any combination thereof.

7. The method as claimed in claim 6, wherein the solution comprises a solvent selected from the group consisting of water, acetic acid, methanol, ethanol, butane-1,4-diol, benzyl alcohol, 1-methoxypropan-2-ol, and any combination thereof.

8. The method as claimed in any one of claims 5 to 7, wherein solution is an acidic aqueous solution comprising medetomidine, or the enantiomer, salt or base thereof, having a pH below 7, preferably selected within an interval of from 4 to 6, and more preferably selected within an interval of from 4.5 to 5.5, such as about 5.0.

9. The method as claimed in claim 8, further comprising:
dissolving medetomidine, or the enantiomer, salt or base thereof, in an acidic aqueous solvent, preferably a mixture of at least one carboxylic acid and water, to form a concentrated acidic aqueous solution having a first pH; and
diluting the concentrated acid aqueous solution with water to form the acidic aqueous solution having a second pH that is below 7, wherein the first pH is below the second pH.

10. The method as claimed in any one of claims 1 to 9, wherein impregnating the at least a portion of the wood comprises impregnating the wood with the composition.

11. The method as claimed in any one of claims 1 to 10, wherein impregnating the at least a portion of the wood comprises impregnating the at least a portion of the wood with the composition in a closed high-pressure system

12. The method as claimed in any one of claims 1 to 10, wherein impregnating the at least a portion of the wood comprises impregnating the at least a portion of the wood with the composition under vacuum.

13. The method as claimed in any one of claims 1 to 10, wherein impregnating the at least a portion of the wood comprises impregnating the at least a portion of the wood with the composition while applying oscillating pressure or a sequence of vacuum cycles.

14. The method as claimed in any one of claims 1 to 10, wherein impregnating the at least a portion of the wood comprises immersing the at least a portion of the wood in the composition.

15. Use of a composition comprising medetomidine, or an enantiomer, salt or base thereof, in an amount of at least 0.05 wt % based on a total weight of the composition for reducing or preventing attacks of marine woodborers on wood present in a marine environment.

16. The use as claimed in claim 1, wherein the composition comprises medetomidine, or the enantiomer, salt or base thereof, in an amount ranging from 0.05 wt % to 5 wt % based on the total weight of the composition.

17. The use as claimed in claim 16, wherein the composition comprises medetomidine, or the enantiomer, salt or base thereof, in an amount ranging from 0.1 wt % to 5 wt % based on the total weight of the composition, preferably in an amount ranging from 0.1 wt % to 2.5 wt % based on the total weight of the composition.

18. The use as claimed in claim 17, where the composition comprises medetomidine, or the enantiomer, salt or base thereof, in an amount ranging from 0.5 wt % to 2.5 wt % based on the total weight of the composition, preferably in an amount ranging from 0.5 wt % to 1.0 wt % based on the total weight of the composition.

19. The use as claimed in any one of claims 15 to 18, wherein the composition is a solution comprising medetomidine, or the enantiomer, salt or base thereof.

20. The use as claimed in claim 19, wherein the solution comprises a solvent selected from the group consisting of water, a carboxylic acid, an alcohol, and any combination thereof.

21. The use as claimed in claim 20, wherein the solution comprises a solvent selected from the group consisting of water, acetic acid, methanol, ethanol, butane-1,4-diol, benzyl alcohol, 1-methoxypropan-2-ol, and any combination thereof.

22. The use as claimed in any one of claims 20 to 21, wherein solution is an acidic aqueous solution comprising medetomidine, or the enantiomer, salt or base thereof, having a pH below 7, preferably selected within an interval of from 4 to 6, and more preferably selected within an interval of from 4.5 to 5.5, such as about 5.0.
